(19) United States
(12) Patent Application Publication
(10) Pub. No.: US 2011/0048377 A1
(43) Pub. Date: Mar. 3, 2011

(54) FUEL SUPPLYING SYSTEM OF LPI ENGINE

(75) Inventor: Ju Tae Song, Suwon-city (KR)

(73) Assignee: Hyundai Motor Company, Seoul (KR)

(21) Appl. No.: 12/622,282

(22) Filed: Nov. 19, 2009

(30) Foreign Application Priority Data
Aug. 26, 2009 (KR) 10-2009-0079450

(51) Int. Cl. F02M 69/04

(52) U.S. Cl. 123/445

(57) ABSTRACT

A fuel supplying system of a liquid propane injection (LPI) engine, may include a fuel tank for storing fuel, a main fuel pump connected to the fuel tank and disposed at the exterior of the fuel tank, a fuel supply line connecting the main fuel pump and the engine to supply fuel from the main fuel pump to the engine, and a fuel return line connecting the engine and the interior of the fuel tank to return fuel from the engine to the interior of the fuel tank, wherein a sub-fuel pump is provided to the interior of the fuel tank and connected to the fuel supply line through a sub-fuel pump connecting pipe, the sub-fuel pump being operated when a predetermined condition is satisfied.

### CROSS-REFERENCE TO RELATED APPLICATION

The present application claims priority to Korean Patent Application No. 10-2009-0079450 filed on Aug. 26, 2009, the entire contents of which are incorporated herein for all purposes by this reference.

### BACKGROUND OF THE INVENTION

1. Field of the Invention

The present invention relates to a fuel supplying system of a liquid propane injection (LPI) engine, and more particularly to a fuel supplying system of an LPI engine that is capable of improving maintainability and workability.

2. Description of Related Art

An LPI engine includes an LPI fuel pump feed therein so as to realize stability of fuel supplying performance when forcedly feeding fuel thereto.

That is, the fuel pump is mounted inside a fuel tank, and liquid-state LPG fuel that is forcedly fed is injected by an injector.

The LPI engine is suitable for corresponding to strict emission regulations, and can improve engine starting in winter while inducing an emission output reduction of the engine.

As shown in FIG. 2, a conventional fuel supplying system of LPI engine includes a fuel tank 10 in which a fuel pump 12 is mounted for feeding liquid-state fuel to an engine 20, a fuel supply line 30 with one end thereof connected to the fuel pump 10 and the other end thereof connected to an injector connected to the engine 20, and a fuel return line 40 with one end thereof connected to the engine 20 and the other end thereof connected to the fuel tank 10.

The fuel supplied from the fuel pump 12 is injected to a combustion chamber through the fuel supply line 30 and the injector sequentially, and residual fuel is returned to the fuel tank 10 through the fuel return line 40.

Meanwhile, a cut-off valve 32 for blocking fuel supply in case of engine stop and a temperature sensor 34 for detecting temperature of the fuel are mounted at the fuel supply line 30.

Further, a pressure detecting sensor 49 for detecting pressure of the fuel and a regulator unit 48 for maintaining pressure of the fuel within a predetermined pressure range are mounted at the fuel return line 40.

However, in case of malfunction of the fuel pump, after the high-pressure LPG fuel is extracted from the fuel tank by a gas extractor, the fuel tank must be cut open to replace the pump and the tank should then be patched, since the conventional LPI fuel pump is mounted inside the LPI fuel tank for feeding fuel to the engine.

In the case, the gas extraction is only allowed in a designated facility that complies with safety restrictions resulting in a long waiting time for customers.

Therefore, labor for extracting the gas is increased, and thereby customers have complaints, particularly taxi drivers.

Further, parts and cost of materials for compensating for noise, vibration, and harshness (NVH) of the fuel pump repair are heavy.

Further, since many parts are welded inside the fuel tank, thermal distortion occurred at a plate of the tank, and scale resulting in deterioration of durability of the fuel pump are generated in a welding process.

In addition, a problem occurs in that site workers evade the repairing and checking of the LPI fuel tank due to safety questions and unpleasant feeling caused by inhalation of gas.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a fuel supplying system of a liquid propane injection (LPI) engine having advantages of improving performance of maintainability and workability.

In an aspect of the present invention, the fuel supplying system of a liquid propane injection (LPI) engine, may include a fuel tank for storing fuel, a main fuel pump connected to the fuel tank and disposed at the exterior of the fuel tank, a fuel supply line connecting the main fuel pump and the engine to supply fuel from the main fuel pump to the engine, and a fuel return line connecting the engine and the interior of the fuel tank to return fuel from the engine to the interior of the fuel tank, wherein a sub-fuel pump is provided to the interior of the fuel tank and connected to the fuel supply line through a sub-fuel pump connecting pipe, the sub-fuel pump being operated when a predetermined condition is satisfied.

The sub-fuel pump connecting pipe may be connected to an exhaust pipe disposed at the interior of the fuel tank, and the sub-fuel pump connecting pipe and the exhaust pipe may be connected to the fuel supply line through a one-way check valve disposed at a downstream side of a joining position of the sub-fuel pump connecting pipe and the exhaust pipe.

The predetermined condition may be satisfied when pressure of the interior of the fuel tank is lower than a predetermined pressure.

The one-way check valve may prevent backflow of the fuel into the fuel tank.

The fuel supplying system may further include a regulator unit at a downstream side of the main fuel pump.

In another aspect of the present invention, the fuel supplying system of an LPI engine may include a fuel tank for storing fuel, a main fuel pump connected to the fuel tank and disposed at the exterior of the fuel tank, a fuel supply line connecting the main fuel pump and the engine to feed fuel from the main fuel pump to the engine, and a fuel return line connecting the engine and the fuel tank to return fuel from the engine to the interior of the fuel tank, and a sub-fuel pump disposed inside the fuel tank and connected to the fuel supply line through a sub-fuel fuel pump connecting pipe, wherein the main fuel pump is operated while driving, and the sub-fuel pump is operated under a predetermined condition.

The predetermined condition may be satisfied when pressure of the interior of the fuel tank is lower than a predetermined pressure.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram showing a fuel supplying system of LPI engine according to an exemplary embodiment of the present invention.

FIG. 2 is a schematic diagram showing a conventional fuel supplying system of LPI engine.

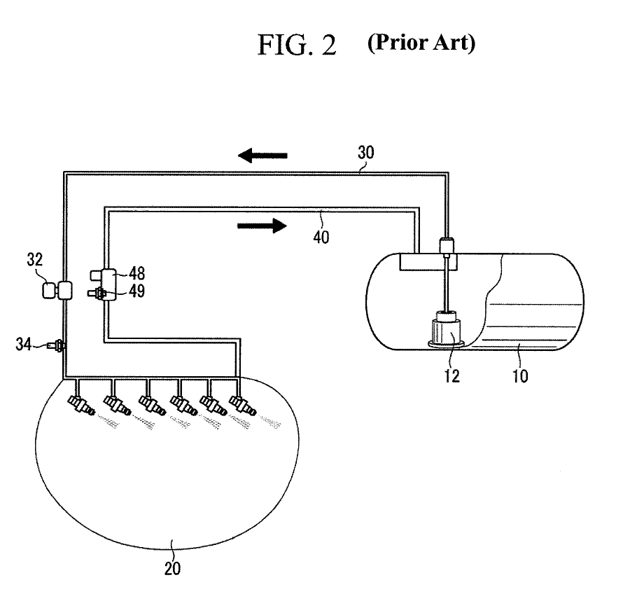

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

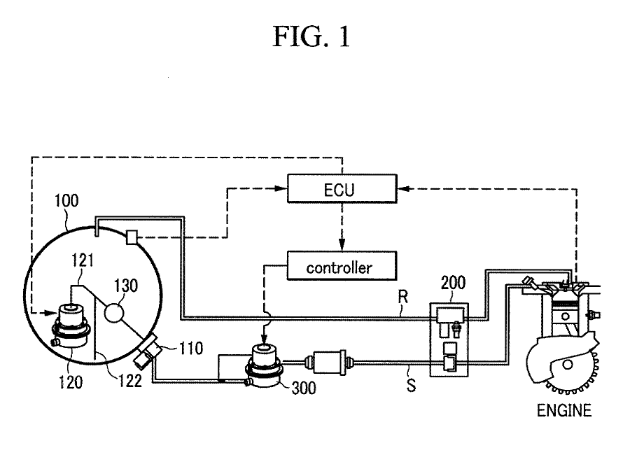

FIG. 1 is a schematic diagram showing a fuel supplying system of a liquid propane fuel (LPI) engine according to an exemplary embodiment of the present invention.

As shown in FIG. 1, a fuel tank 100, a regulator unit 200, and an engine are connected to each other through a fuel supply line S and a fuel return line R so as to feed liquid-state fuel in the fuel tank 100 to the engine via the regulator unit 200, and then unused liquid-state fuel is returned to the fuel tank 100 through the regulator unit 200.

The regulator unit 200, as a conventional device, maintains supply pressure of the liquid-state fuel supplied to the engine.

Further, a fuel return line R connecting the engine and the fuel tank 100 is connected to the regulator unit 200 so as to return unused fuel to the fuel tank 100.

In addition, a pressure sensor detecting fuel pressure of fuel returning to the fuel tank 100 may be mounted in the fuel return line R connected to the regulator unit 200, and furthermore a pressure regulator may be mounted therein so as to return the fuel to the fuel tank 100 only when the fuel pressure exceeds a predetermined pressure.

Although not shown in the drawings, the fuel supplying system can be controlled by an ECU.

Further, a main fuel pump 300 is mounted at the fuel supply line S disposed between the fuel tank 100 and the regulator unit 200 so as to continuously forcedly feed the fuel in the fuel tank 100 to the engine. Herein, the main fuel pump 300 may be an external fuel pump disposed outside the fuel tank 100.

Further, a pressure detecting sensor 110 may be mounted at the fuel tank 100 for detecting internal pressure of the fuel tank 100. The pressure sensor 110 can be controlled by the ECU.

In addition, a sub-fuel pump 120 is mounted inside the fuel tank 100.

The sub-fuel pump 120 is operated only when pressure detected by the pressure sensor 110 is less than 0.5 bar.

At this time, the fuel supplied from the sub-fuel pump 120 is supplied to the exterior portion of the fuel tank 100 through a sub-fuel pump connecting pipe 121.

Herein, a one-way check valve 130 is provided to prevent backflow of the fuel before the fuel flows from the fuel tank 100 to the exterior thereof.

During the fuel supply, if the fuel supply line S is blocked or the regulator unit 200 malfunctions resulting in deterioration of the fuel flow, pressure of the fuel supply line S is greater than pressure of the sub-fuel pump 120.

At this time, the fuel flows backward into the sub-fuel pump 120 through a recirculation line provided from the outlet of the main fuel pump to the inlet thereof due to the high pressure of the fuel supply line S.

To avoid the backflow resulting in damage to the sub-fuel pump 120, a one-way check valve 130 preventing the backflow should be provided therewith.

Meanwhile, a separate exhaust pipe 122 that is diverged from the sub-fuel pump connecting pipe 121 supplies the fuel to the engine.

That is, the sub-fuel pump connecting pipe 121 and the exhaust pipe 122 are joined at the one-way check valve 130.

Thus, the fuel in the fuel tank 100 is supplied to the main fuel pump 300 through the exhaust pipe 122 only by using internal pressure thereof, and the fuel in the fuel tank 100 is supplied to the main fuel pump 300 through the sub-fuel pump connecting pipe 121 by an operation of the sub-fuel pump 120 in the case that the internal pressure of the fuel tank 100 is less than 0.5 bar.

The operation of a fuel supplying system of an LPI engine according to an exemplary embodiment of the present invention will be hereinafter described in detail.

During driving, when pressure detected by the pressure sensor 110 is greater than 0.5 bar, the fuel flows into the main fuel pump 300 through the exhaust pipe 122 in a state in which a control valve of the fuel supply line S is disposed between the one-way check valve 130 mounted inside the fuel tank 100 and the main fuel pump 300.

The main fuel pump 300 is operating continuously during driving,

At this time, the main fuel pump 300 pressurizes the liquid-state fuel from the fuel tank 100 by a predetermined pressure in comparison with the pressure of the fuel tank 100. For example, a pressure of 5 bar is added to a pressure of the fuel pump 100 that is 3 bar, and thereby pressure of liquid-state fuel that is 8 bar is supplied by the fuel supply line S.

Meanwhile, if pressure detected by the pressure sensor 110 is less than 0.5 bar, the ECU controls the sub-fuel pump 120 disposed inside the fuel tank 100 to be operated.

And then, the fuel is supplied to the main fuel pump 300 through the sub-fuel pump connecting pipe 121 and the one-way check valve 130 by using a pumping operation of the sub-fuel pump 120.

While the liquid-state fuel is supplied to the engine through the regulator unit 200, a portion of the fuel is injected by the injector and ignited, and a remaining portion thereof is returned to the fuel tank 100 through the regulator unit 200 via the fuel return line R.

In this way, the liquid-state fuel returned through the fuel return line R is passed through the regulator unit 200 via an opened return valve, and then it is stored in the fuel tank 100.

Meanwhile, the liquid-state fuel flowing into the fuel return line R is expanded according to an increase in temperature. At that time, the pressure is increased to 8 bar as described above, and then the fuel flows into the fuel tank 100 again since the pressure adjuster of the regulator unit 200 and a return valve in the fuel return line R closed are sequentially opened.

In case of malfunction of the main fuel pump 300, only the main fuel pump 300 needs to be disassembled from the fuel supply line S for being repaired or replaced in a state that the control valve mounted at the fuel supply line S between the fuel tank 100 and the main fuel pump 300 is closed for a cut-off from the fuel tank 100, and thus the repair is simplified regardless of working place. Further, because it is unnecessary to extract all the fuel from the fuel tank 100, a loss of the fuel in the process is minimized.

Further, during the fuel supply, if the fuel supply line S between the main fuel pump 300 and the regulator unit 200 is blocked or malfunctions by sludge mixed in the liquid-state fuel, pressure of the fuel supply line S is greater than pressure of the sub-fuel pump 120. However, a one-way check valve prevents backflow of the supplied liquid-state fuel in order to reduce damage to the sub-fuel pump 120.

Further, because the sub-fuel pump 120 is operated only when internal pressure of the fuel tank 100 is lower than a predetermined pressure, malfunction of the sub-fuel pump 120 is minimized, and thereby longevity thereof is improved.

For convenience in explanation and accurate definition in the appended claims, the term “exterior” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel supplying system of a liquid propane injection (LPI) engine, comprising:
a fuel tank for storing fuel;
a main fuel pump connected to the fuel tank and disposed at the exterior of the fuel tank;
a fuel supply line connecting the main fuel pump and the engine to supply fuel from the main fuel pump to the engine; and
a fuel return line connecting the engine and the interior of the fuel tank to return fuel from the engine to the interior of the fuel tank,
wherein a sub-fuel pump is provided to the interior of the fuel tank and connected to the fuel supply line through a sub-fuel pump connecting pipe, the sub-fuel pump being operated when a predetermined condition is satisfied.

2. The fuel supplying system of claim 1, wherein the sub-fuel pump connecting pipe is connected to an exhaust pipe disposed at the interior of the fuel tank, and
the sub-fuel pump connecting pipe and the exhaust pipe are connected to the fuel supply line through a one-way check valve disposed at a downstream side of a joining position of the sub-fuel pump connecting pipe and the exhaust pipe.

3. The fuel supplying system of claim 2, wherein the predetermined condition is satisfied when pressure of the interior of the fuel tank is lower than a predetermined pressure.

4. The fuel supplying system of claim 2, wherein the one-way check valve prevents backflow of the fuel into the fuel tank.

5. The fuel supplying system of claim 1 further comprising a regulator unit at a downstream side of the main fuel pump.

6. A fuel supplying system of an LPI engine, comprising:
a fuel tank for storing fuel;
a main fuel pump connected to the fuel tank and disposed at the exterior of the fuel tank;
a fuel supply line connecting the main fuel pump and the engine to feed fuel from the main fuel pump to the engine; and
a fuel return line connecting the engine and the fuel tank to return fuel from the engine to the interior of the fuel tank; and
a sub-fuel pump disposed inside the fuel tank and connected to the fuel supply line through a sub-fuel fuel pump connecting pipe,
wherein the main fuel pump is operated while driving, and the sub-fuel pump is operated under a predetermined condition.

7. The fuel supplying system of claim 6, wherein the predetermined condition is satisfied when pressure of the interior of the fuel tank is lower than a predetermined pressure.
